(19) United States
(12) Patent Application Publication
(10) Pub. No.: US 2022/0080632 A1
(43) Pub. Date: Mar. 17, 2022

(54) Resin Molded Article and Method for Producing Same

(71) Applicant: Spiber Inc., Yamagata (JP)

(72) Inventors: Masami Takemoto, Toyota-shi, Aichi (JP); Hideo Hirata, Toyota-shi, Aichi (JP); Susumu Kiyosue, Toyota-shi, Aichi (JP); Kazuhiro Uchida, Toyota-shi, Aichi (JP); Masahiro Asakawa, Toyota-shi, Aichi (JP)

(73) Assignee: Spiber Inc., Yamagata (JP)

(21) Appl. No.: 17/279,082

(22) PCT Filed: Sep. 27, 2019
(86) PCT No.: PCT/JP2019/038384

§ 371 Date: Mar. 23, 2021

(30) Foreign Application Priority Data
Sep. 28, 2018 (JP) 2018-185586

(51) Int. Cl. B29C 45/00

(52) U.S. Cl. CPC B29C 45/0001; B29K 2023/12

(57) ABSTRACT

A resin molded article contains a thermoplastic resin, a filler dispersed in the thermoplastic resin, and protein short fibers each having a fiber length of 24 mm or less and dispersed in the thermoplastic resin.

### TECHNICAL FIELD

The present invention relates to a resin molded article and a method for manufacturing the same.

### BACKGROUND ART

Conventionally, as a method for improving the mechanical strength of a resin molded article, a method for blending a filler such as glass fibers or carbon fibers has been known. For example, Patent Literature 1 discloses an injection molded article obtained from a thermoplastic resin composition obtained by adding glass fibers to a thermoplastic resin.

### CITATION LIST

### Patent Literature

### Patent Literature 1: JP 2009-275172 A

### SUMMARY OF INVENTION

### Technical Problem

As a method for molding a resin composition, a method for solidifying a resin composition that is fluidized by heating or the like in a predetermined shape is known. However, when this method is applied to a resin composition containing a filler, the filler may be broken due to shearing force or the like caused by a resin flow, or the filler may be unevenly distributed in a fluid material. As a result, a physical property improving effect of the filler cannot be sufficiently obtained in some cases, or physical properties may be biased in a molded article.

Therefore, an object of the present invention is to provide a homogeneous resin molded article having good tensile characteristics. Another object of the present invention is to provide a method for manufacturing a resin molded article, capable of easily obtaining a homogeneous resin molded article having good tensile characteristics by suppressing breakage and uneven distribution of a filler in a fluid material.

### Solution to Problem

One aspect of the present invention relates to a resin molded article containing a thermoplastic resin, a filler dispersed in the thermoplastic resin, and protein short fibers each having a fiber length of 24 mm or less and dispersed in the thermoplastic resin.

The resin molded article can exhibit good tensile characteristics throughout the molded article because the filler and the protein short fibers are dispersed in the thermoplastic resin.

In one mode, the filler may contain carbon fibers.

In one mode, the protein short fibers may contain spider silk fibroin-like protein fibers.

In one mode, the above-described resin molded article may be a molded article of a kneaded product of the thermoplastic resin, the filler, and the protein short fibers.

Another aspect of the present invention relates to a method for manufacturing a resin molded article, the method including: a preparatory step of preparing a thermoplastic resin, a filler, and protein short fibers each having a fiber length of 24 mm or less; a mixing step of obtaining a fluid material containing a melt of the thermoplastic resin, and the filler and the protein short fibers dispersed in the melt; and a cooling step of cooling the fluid material.

In the above manufacturing method, by allowing the filler and the protein short fibers to coexist in the fluid material, breakage and uneven distribution of the filler in the fluid material are suppressed. As a result, according to the manufacturing method, a homogeneous resin molded article having good tensile characteristics can be easily obtained.

In one mode, the mixing step may be a step of kneading a melt of the thermoplastic resin, the filler, and the protein short fibers to obtain the fluid material.

In one mode, the cooling step may be a step of injecting the fluid material into a die and cooling the fluid material injected into the die.

In one mode, the filler may contain carbon fibers.

In one mode, a ratio C1/C2 of an average fiber length C1 of the protein short fibers with respect to an average fiber length C2 of the carbon fibers in the preparatory step may be 0.5/7 to 7/7.

In one mode, the protein short fibers may contain spider silk fibroin-like protein fibers.

### Advantageous Effects of Invention

The present invention provides a homogeneous resin molded article having good tensile characteristics. In addition, the present invention provides a method for manufacturing a resin molded article, capable of easily obtaining a homogeneous resin molded article having good tensile characteristics by suppressing breakage and uneven distribution of a filler in a fluid material.

### BRIEF DESCRIPTION OF DRAWINGS

FIG. 1 is a schematic diagram illustrating an example of a spinning apparatus for manufacturing protein fibers.

FIG. 2(a) is a diagram illustrating a fiber length distribution of carbon fibers in Example 1, and FIG. 2(b) is a diagram illustrating a fiber length distribution of carbon fibers in Comparative Example 1.

FIG. 3(a) is a diagram illustrating results of a tensile test in Example 1, and FIG. 3(b) is a diagram illustrating results of a tensile test in Comparative Example 1.

### DESCRIPTION OF EMBODIMENTS

Hereinafter, a preferred embodiment of the present invention will be described. However, the present invention is not limited to the following embodiment.

(Resin Molded Article)

A resin molded article according to the present embodiment includes a thermoplastic resin, a filler dispersed in the thermoplastic resin, and protein short fibers each having a fiber length of 24 mm or less and dispersed in the thermoplastic resin.

The resin molded article according to the present embodiment can exhibit good tensile characteristics throughout the molded article because the filler and the protein short fibers are dispersed in the thermoplastic resin.

In the present embodiment, the thermoplastic resin is not particularly limited as long as being a thermoplastic resin that can disperse the filler and the protein short fibers as a matrix resin. Examples of the thermoplastic resin include a polyamide resin (for example, nylon), polypropylene, polyethylene, polystyrene, polyacetal, polycarbonate, ABS, AES, PET, PBT, PPS, LCP, and PEEK.

The content of the thermoplastic resin may be, for example, 40% by volume or more, and preferably 50% by volume or more and more preferably 60% by volume or more from a viewpoint of dispersibility of the protein fibers.

As the filler, a known filler blended in a conventional resin molded article can be used without particular limitation. The shape of the filler is not particularly limited, and may be, for example, a fibrous shape, a granular shape including a spherical shape and an ellipsoidal shape, and a plate shape. A material constituting the filler is not particularly limited, and examples thereof include carbon (carbon fibers and the like), glass (glass fibers, glass beads, glass balloons, and the like), talc, mica, calcium carbonate, aluminum hydroxide, barium sulfate, whisker, wollastonite, and montmorillonite.

The filler is preferably a fibrous filler from a viewpoint that an effect of suppressing breakage of the filler in the fluid material can be significantly obtained in a manufacturing method described later. Examples of the fibrous filler include glass fibers, carbon fibers, metal powders such as copper and aluminum, and chemical fibers such as cellulose, PA, PET, aramid, PP, and PC. Among these materials, carbon fibers are particularly preferable.

The fiber length of the fibrous filler is not particularly limited, and may be, for example, 7 mm or less.

Note that the resin molded article may contain a fibrous filler having a shorter fiber length than the above value due to breakage or the like during molding. For example, 90% by mass or more of the fibrous filler preferably has a fiber length of 1 mm or more (more preferably 5 mm or more). In the present embodiment, since breakage of the fibrous filler is suppressed in the manufacturing method described later, a resin molded article containing such a fibrous filler can be easily obtained.

The content of the filler is not particularly limited, and may be, for example, 40% by volume or more, and preferably 50% by volume or more, and more preferably 60% by volume or more from a viewpoint of dispersibility and physical properties.

In the present embodiment, the protein short fiber can be said to be a fiber constituted by a protein (protein fiber) having a fiber length of 24 mm or less.

The fiber length of the protein short fiber is not particularly limited as long as being 24 mm or less, and may be, for example, 12 mm or less or 7 mm or less.

The fiber length of the protein short fiber is preferably 0.1 mm or more, and more preferably 1 mm or more from a viewpoint of further improving the mechanical strength of the resin molded article. Note that the resin molded article may contain protein short fibers each having a shorter fiber length than the above value due to breakage or the like during molding. For example, 90% by mass or more of the protein short fibers preferably each have a fiber length of 1 mm or more (more preferably 4 mm or more).

The content of the protein short fibers may be, for example, 0.5% by volume or more, and preferably 1% by volume or more from a viewpoint of dispersibility and an effect of suppressing breakage of the filler. The content of the protein short fibers may be, for example, 60% by volume or less, preferably 50% by volume or less, and more preferably 40% by volume or less.

A protein constituting the protein short fibers is preferably a structural protein. Here, the structural protein refers to a protein forming a biological structure or a protein derived therefrom. That is, the structural protein may be a structural protein derived from a natural product, or a modified protein obtained by modifying a part of an amino acid sequence of a structural protein derived from a natural product (for example, 10% or less of the amino acid sequence) depending on the amino acid sequence.

Specific examples of the structural protein include fibroin (for example, spider silk or silkworm silk), collagen, resilin, elastin, keratin, and proteins derived from these.

Examples of the fibroin-like protein (fibroin or a protein derived therefrom) include a protein containing a domain sequence represented by formula 1: [(A)ₙ motif-REP1]ₘ. Here, in formula 1, in the (A)ₙ motif, A represents an alanine residue, and n may be preferably an integer of 2 to 27, an integer of 4 to 20, an integer of 8 to 20, an integer of 10 to 20, an integer of 4 to 16, an integer of 8 to 16, or an integer of 10 to 16. In formula 1, the number of alanine residues with respect to the total number of amino acid residues in the (A)ₙ motif only needs to be 40% or more, and may be 60% or more, 70% or more, 80% or more, 90% or more, or 100% (which means that the (A)ₙ motif is constituted only by alanine residues). REP1 represents an amino acid sequence constituted by 10 to 200 amino acid residues. m represents an integer of 10 to 300. The plurality of (A)ₙ motifs may be the same amino acid sequence or different amino acid sequences. The plurality of REP1s may be the same amino acid sequence or different amino acid sequences. Examples of the fibroin-like protein include a protein containing an amino acid sequence represented by SEQ ID NO: 1.

Examples of the collagen-like protein (collagen or a protein derived therefrom) include a protein containing a domain sequence represented by formula 2: [REP2]ₚ. Here, in formula 2, p represents an integer of 5 to 300. REP2 represents an amino acid sequence constituted by Gly-X-Y, and X and Y each represent any amino acid residue other than Gly. The plurality of REP2s may be the same amino acid sequence or different amino acid sequences. Examples of the collagen-like protein include a protein containing an amino acid sequence represented by SEQ ID NO: 2. Here, the amino acid sequence represented by SEQ ID NO: 2 is obtained by adding an amino acid sequence (tag sequence and hinge sequence) represented by SEQ ID NO: 6 to an N-terminal of an amino acid sequence from the 301st residue to the 540th residue corresponding to a repeat portion and a motif of a partial sequence of human collagen type 4 (NCBI GenBank accession number: CAA56335.1, GI: 3702452) obtained from the NCBI database.

Examples of the resilin-like protein (resilin or a protein derived from resilin) include a protein containing a domain sequence represented by formula 3: [REP3]_{q}. Here, in formula 3, q represents an integer of 4 to 300. REP3 represents an amino acid sequence constituted by Ser-J-J-Tyr-Gly-U-Pro. J represents any amino acid residue, preferably an amino acid residue selected from the group consisting of Asp, Ser, and Thr. U represents any amino acid residue, preferably an amino acid residue selected from the group consisting of Pro, Ala, Thr, and Ser. The plurality of REP3s may be the same amino acid sequence or different amino acid sequences. Examples of the resilin-like protein include a protein containing an amino acid sequence represented by SEQ ID NO: 3. Here, the amino acid sequence represented by SEQ ID NO: 3 is obtained by adding an amino acid sequence (tag sequence) represented by SEQ ID NO: 7 to an N-terminal of an amino acid sequence from the 19th residue to the 321st residue of a sequence in which Th at the 87th residue is replaced with Ser and Asn at the 95th residues is replaced with Asp in an amino acid sequence of resilin (NCBI GenBank accession number NP 611157, Gl: 24654243).

Examples of the elastin-like protein (elastin or a protein derived from elastin) include a protein having an amino acid sequence of NCBI GenBank accession number AAC98395 (human), 147076 (sheep), or NP786966 (bovine). Examples of the elastin-like protein include a protein containing an amino acid sequence represented by SEQ ID NO: 4. Here, the amino acid sequence represented by SEQ ID NO: 4 is obtained by adding an amino acid sequence (tag sequence and hinge sequence) represented by SEQ ID NO: 6 to an N-terminal of an amino acid sequence from the 121st residue to the 390th residue of an amino acid sequence of NCBI GenBank accession number AAC98395.

Examples of the keratin-like protein (keratin or a protein derived from keratin) include Capra hircus type I keratin. Examples of the keratin-like protein include a protein containing an amino acid sequence represented by SEQ ID NO: 5 (amino acid sequence of NCBI GenBank accession number ACY30466).

The structural protein is preferably a fibroin-like protein, and more preferably a spider silk fibroin-like protein.

As the protein according to the present embodiment, for example, a protein produced by expressing a nucleic acid encoding a target protein by a host transformed with an expression vector having the nucleic acid sequence and one or more regulatory sequences operably linked to the nucleic acid sequence.

A method for manufacturing the nucleic acid encoding a target protein is not particularly limited. For example, the nucleic acid can be manufactured by a method for performing amplification and cloning by a polymerase chain reaction (PCR) or the like using a gene encoding a natural structural protein, or by chemical synthesis. The method for chemically synthesizing the nucleic acid is not particularly limited. For example, the nucleic acid can be chemically synthesized by a method for linking oligonucleotides automatically synthesized using AKTA oligopilot plus 10/100 (manufactured by GE Healthcare Japan Co., Ltd.) or the like with PCR or the like based on amino acid sequence information of a structural protein obtained from the NCBI web database or the like. At this time, in order to facilitate purification and confirmation of a protein, a nucleic acid encoding a protein containing an amino acid sequence obtained by adding an amino acid sequence formed of a start codon and a His10 tag to an N-terminal of the above amino acid sequence may be synthesized.

The regulatory sequence is a sequence that controls expression of a recombinant protein in a host (for example, a promoter, an enhancer, a ribosome binding sequence, or a transcription termination sequence), and can be appropriately selected depending on the type of host. As the promoter, an inducible promoter that functions in a host cell and can induce expression of a target protein may be used. The inducible promoter is a promoter that can control transcription by presence of an inducing substance (expression inducer), absence of a repressor molecule, or a physical factor such as an increase or decrease in temperature, osmotic pressure, or pH value.

The type of expression vector may be a plasmid vector, a viral vector, a cosmid vector, a phosmid vector, an artificial chromosome vector, or the like, and can be appropriately selected depending on the type of host. As the expression vector, a vector capable of autonomous replication in a host cell or capable of integration of a host into a chromosome, and containing a promoter at a position where a nucleic acid encoding a target protein can be transcribed is preferably used.

As the host, either a prokaryote or a eukaryote such as yeast, filamentous fungi, insect cells, animal cells, or plant cells can be preferably used.

Preferred examples of the prokaryote include bacteria belonging to Escherichia, Brevibacillus, Serratia, Bacillus, Microbacterium, Brevibacterium, Corynebacterium, and Pseudomonas.

When the prokaryote is used as a host, examples of a vector into which a nucleic acid encoding a target protein is introduced include pBTrp2 (manufactured by Boehringer Mannheim), pGEX (manufactured by Pharmacia), pUC18, pBluescriptII, pSupex, pET22b, pCold, pUB110, and pNCO2 (JP 2002-238569 A).

Examples of a host of the eukaryote include yeast and filamentous fungi (molds and the like). Examples of the yeast include yeast belonging to Saccharomyces, Pichia, and Schizosaccharomyces. Examples of the filamentous fungi include filamentous fungi belonging to Aspergillus, Penicillium, and Trichoderma.

When the eukaryote is used as a host, examples of a vector into which a nucleic acid encoding a target protein is introduced include YEp13 (ATCC37115) and YEp24 (ATCC37051).

As a method for introducing an expression vector into the host cell, any method for introducing DNA into the host cell can be used. Examples thereof include a method using calcium ions [Proc. Natl. Acad. Sci. USA, 69, 2110 (1972)], an electroporation method, a spheroplast method, a protoplast method, a lithium acetate method, and a competent method.

As a method for expressing a nucleic acid by a host transformed with an expression vector, in addition to direct expression, secretory production, fusion protein expression, and the like can be performed according to the method described in Molecular Cloning Second Edition.

The target protein can be manufactured, for example, by culturing a host transformed with an expression vector in a culture medium, generating and accumulating the protein in the culture medium, and collecting the protein from the culture medium. A method of culturing the host in the culture medium can be performed according to a method usually used for culturing a host.

When the host is a prokaryote such as Escherichia coli or a eukaryote such as yeast, as the culture medium of the host, either a natural medium or a synthetic medium may be used as long as the medium contains a carbon source, a nitrogen source, an inorganic salt, and the like that can be assimilated by the host, and can efficiently culture the host.

The carbon source only needs to be assimilated by the transformed host, and examples thereof include glucose, fructose, sucrose, molasses containing these, a carbohydrate such as starch or a starch hydrolyzate, an organic acid such as acetic acid or propionic acid, and an alcohol such as ethanol or propanol.

Examples of the nitrogen source include an ammonium salt of an inorganic or an organic acid, such as ammonia, ammonium chloride, ammonium sulfate, ammonium acetate, or ammonium phosphate, other nitrogen-containing compounds, peptone, meat extract, yeast extract, corn steep liquor, a casein hydrolyzate, soybean cake and a soybean cake hydrolyzate, and various fermented bacterial cells and digested products thereof.

Examples of the inorganic salt include primary potassium phosphate, secondary potassium phosphate, magnesium phosphate, magnesium sulfate, sodium chloride, ferrous sulfate, manganese sulfate, copper sulfate, and calcium carbonate.

A prokaryote such as Escherichia coli or a eukaryote such as yeast can be cultured under aerobic conditions such as shaking culture or deep aeration stirring culture. The culture temperature is, for example, 15 to 40° C. The culture time is usually 16 hours to seven days. The pH of a culture medium during culture is preferably maintained at 3.0 to 9.0. The pH of the culture medium can be adjusted using an inorganic acid, an organic acid, an alkaline solution, urea, calcium carbonate, ammonia, or the like.

An antibiotic such as ampicillin or tetracycline may be added to the culture medium as needed during culture. When a microorganism transformed with an expression vector using an inducible promoter is cultured as a promoter, an inducer may be added to a medium as needed. For example, when a microorganism transformed with an expression vector using a lac promoter is cultured, isopropyl-β-D-thiogalactopyranoside or the like may be added to a medium, and when a microorganism transformed with an expression vector using a trp promoter is cultured, indoleacrylic acid or the like may be added to a medium.

Isolation and purification of a target protein generated and accumulated by a host can be performed by a method usually used. For example, when the protein is expressed in a state where the protein is dissolved in cells, host cells are collected by centrifugation after completion of culture, suspended in an aqueous buffer, and then crushed with an ultrasonic crusher, a French press, a manton gaulin homogenizer, a dynomil, or the like to obtain a cell-free extract. From a supernatant obtained by centrifuging the cell-free extract, a purified sample can be obtained by a method usually used for isolation and purification of a protein. When the protein is expressed by forming an insoluble matter in cells, by similarly collecting, then crushing, and centrifuging host cells, the insoluble matter of the protein is collected as a precipitation fraction. The collected insoluble matter of the protein can be solubilized with a protein modifier. After the operation, a purified protein sample can be obtained by an isolation and purification method similar to the method described above.

When the protein is secreted extracellularly, the protein can be collected from a culture supernatant. That is, by treating the cultured product by a method such as centrifugation to obtain a culture supernatant, and using an isolation and purification method similar to the method described above, a purified sample can be obtained from the culture supernatant.

Examples of the method usually used for isolation and purification of a protein include a solvent extraction method, a salting out method using ammonium sulfate or the like, a desalting method, a precipitation method using an organic solvent, an anion exchange chromatography method using a resin such as diethylaminoethyl (DEAE)-Sepharose or DIAION HPA-75 (manufactured by Mitsubishi Chemical Corporation), a cation exchange chromatography method using a resin such as S-Sepharose FF (manufactured by Pharmacia), a hydrophobic chromatography method using a resin such as butyl Sepharose or phenyl Sepharose, a gel filtration method using a molecular sieve, an affinity chromatography method, a chromatographic focusing method, and an electrophoresis method such as isoelectric point electrophoresis. These methods may be used singly or in combination thereof.

The protein short fiber may be obtained by cutting the above-described protein fiber obtained by spinning a protein to a predetermined fiber length. The protein fiber is preferably a fiber obtained by spinning a structural protein (structural protein fiber), more preferably a fiber obtained by spinning a fibroin-like protein (fibroin-like protein fiber), and particularly preferably a fiber obtained by spinning a spider silk fibroin-like protein (spider silk fibroin-like protein fiber).

The protein fiber can be manufactured by spinning a protein by a known spinning method. That is, when the protein fiber is manufactured, first, a protein manufactured according to the above-described method is added to a solvent such as dimethyl sulfoxide (DMSO), N,N-dimethylformamide (DMF), or hexafluoroisopronol (HFIP) together with an inorganic salt as a dissolution accelerator and dissolved therein to prepare a doping liquid. Subsequently, using this doping liquid (spinning stock solution), spinning is performed by a known spinning method such as wet spinning, dry spinning, or dry-wet spinning to obtain a target protein fiber.

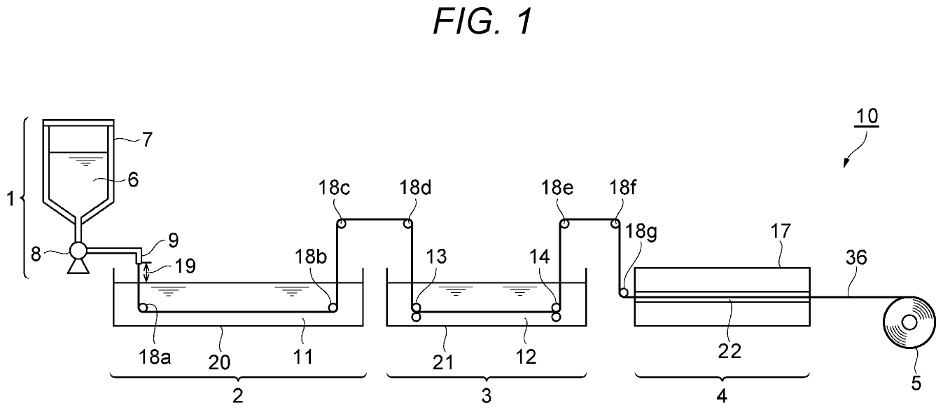

FIG. 1 is a schematic diagram illustrating an example of a spinning apparatus for manufacturing protein fibers. A spinning apparatus 10 illustrated in FIG. 1 is an example of a spinning apparatus for dry-wet spinning, and includes an extrusion device 1, a coagulation bath 20, a washing bath 21, and a drying device 4 in order from an upstream side.

The extrusion device 1 includes a storage tank 7, in which a doping liquid (spinning stock solution) 6 is stored. A coagulation liquid 11 (for example, methanol) is stored in the coagulation bath 20. The doping liquid 6 is pushed out from a nozzle 9 disposed with an air gap 19 between the nozzle 9 and the coagulation liquid 11 by a gear pump 8 attached to a lower end of the storage tank 7. The extruded doping liquid 6 is supplied into the coagulation liquid 11 via the air gap 19. A solvent is removed from the doping liquid 6 in the coagulation liquid 11 to coagulate a protein. The coagulated protein is guided to the washing bath 21, washed by a washing liquid 12 in the washing bath 21, and then sent to the drying device 4 by a first nip roller 13 and a second nip roller 14 disposed in the washing bath 21. At this time, for example, when the rotation speed of the second nip roller 14 is set to be higher than the rotation speed of the first nip roller 13, protein fibers 36 stretched at a ratio corresponding to a rotation speed ratio can be obtained. The protein fibers 36 stretched in the washing liquid 12 are dried while passing through the drying device 4 after leaving the washing bath 21, and then wound up by a winder. In this way, the protein fibers 36 are finally obtained as a wound product 5 wound around the winder by the spinning apparatus 10. Note that reference numerals 18a to 18g represent thread guides.

The coagulation liquid 11 only needs to be an organic solvent capable of extracting a solvent (removing a solvent) from the doping liquid 6 extruded from the nozzle 9. Examples of such an organic solvent include a lower alcohol having 1 to 5 carbon atoms, such as methanol, ethanol, or 2-propanol, and acetone. The coagulation liquid 11 may appropriately contain water. The temperature of the coagulation liquid 11 is preferably 0 to 30° C. A passing distance of the coagulated protein in the coagulation liquid 11 (substantially, a distance from the thread guide 18a to the thread guide 18b) only needs to have a length capable of efficiently remove a solvent, and is, for example, 200 to 500 mm. The residence time in the coagulation liquid 11 may be, for example, 0.01 to 3 minutes, and is preferably 0.05 to 0.15 minutes. In the present embodiment, fibers containing the coagulated protein may be stretched (pre-stretched) in the coagulation liquid 11.

Water can be mainly used as the washing liquid 12. The washing liquid 12 may contain those listed as agents that can be used for the coagulation liquid 11. Note that stretching performed in the washing bath 21 for obtaining the protein fibers may be so-called moist heat stretching performed in warm water, a solution obtained by adding an organic solvent or the like to warm water, or the like. The temperature in this moist heat stretching may be, for example, 50 to 90° C., and is preferably 75 to 85° C. In the moist heat stretching, an unstretched yarn (or pre-stretched yarn) can be stretched, for example, 1 to 10 times, and is preferably stretched 2 to 8 times.

When passing through the drying device 4 in the present embodiment, the protein fibers may be further stretched (so-called dry heat stretching).

A lower limit of the stretch ratio of a final protein fiber is preferably more than 1 time, 2 times or more, 3 times or more, 4 times or more, 5 times or more, 6 times or more, 7 times or more, 8 times or more, or 9 times or more with respect to an unstretched yarn (or pre-stretched yarn), and an upper limit thereof is preferably 40 times or less, 30 times or less, 20 times or less, 15 times or less, 14 times or less, 13 times, 12 times or less, 11 times or less, or 10 times or less.

The resin molded article according to the present embodiment may further contain other components contained in a known resin molded article in addition to the above components. Examples of other components include an anti-deterioration agent, an antistatic agent, an antioxidant, an internal mold release agent, and a surface modifier.

The resin molded article according to the present embodiment can also be said to be a molded article of a kneaded product of a thermoplastic resin, a filler, and protein short fibers.

The kneaded product may be obtained by kneading the components of the resin molded article at a temperature at which the thermoplastic resin melts. A kneading method is not particularly limited, and examples thereof include a method using a kneader, a mixer, a screw disposed in an extruder or an injection molding machine, and the like.

A method for molding the kneaded product is not particularly limited, and examples thereof include a method such as injection press molding, injection compression molding, sheet compression molding, LFT-D molding, flow stamping molding, extrusion molding, sheet molding, film molding, sheet stamping molding, or foam molding.

A preferred embodiment of a method for manufacturing a resin molded article will be described below.

(Method for Manufacturing Resin Molded Article)

The method for manufacturing a resin molded article according to the present embodiment includes: a preparatory step of preparing a thermoplastic resin, a filler, and protein short fibers; a mixing step of obtaining a fluid material containing a melt of the thermoplastic resin, and the filler and the protein short fibers dispersed in the melt; and a cooling step of cooling the fluid material.

In the manufacturing method according to the present embodiment, by allowing the filler and the protein short fibers to coexist in the fluid material, breakage (for example, breakage due to shearing force caused by a resin flow) and uneven distribution of the filler in the fluid material are suppressed. As a result, according to the manufacturing method, a homogeneous resin molded article having good tensile characteristics can be easily obtained. That is, in the present embodiment, the protein short fibers can also be said to be a dispersion accelerator that suppresses breakage and uneven distribution of the filler in the fluid material and efficiently disperses the filler.

In the preparatory step, the thermoplastic resin, the filler, and the protein short fibers are prepared. The thermoplastic resin, the filler, and the protein short fibers may be the thermoplastic resin, the filler, and the protein short fibers in the resin molded article described above, respectively.

In the preparatory step, when the filler contains a fibrous filler (for example, carbon fibers), a ratio C1/C2 of an average fiber length C1 of the protein short fibers with respect to an average fiber length C2 of the fibrous filler is preferably 0.5/7 or more, and more preferably 7/7 or more. With such a ratio of C1/C2, breakage of the fibrous filler in the fluid material is more significantly suppressed.

Note that here, the average fiber length of the fibrous filler indicates a value measured using a needle-shaped particle measuring device (LUZEX_AP manufactured by Nireco Corporation). The average fiber length of the protein short fibers indicates a value measured by taking a photograph using a microscope.

In the mixing step, a fluid material containing a melt of the thermoplastic resin, and the filler and the protein short fibers dispersed in the melt is obtained. The fluid material can be obtained, for example, by heating the thermoplastic resin to obtain a melt of the thermoplastic resin, and adding the filler and the protein short fibers to the melt. The fluid material can also be obtained by heating a raw material mixture containing the thermoplastic resin, the filler, and the protein short fibers.

The heating temperature is not particularly limited as long as being a temperature at which the thermoplastic resin can exhibit sufficient fluidity (that is, a temperature at which a fluid material having sufficient fluidity can be obtained). The heating temperature may be, for example, 120° C. or higher, and is preferably 130° C. or higher. The heating temperature may be, for example, 150° C. or lower, and is preferably 140° C. or lower.

The heating may be performed under pressurization. A pressurizing condition is not particularly limited as long as the thermoplastic resin can exhibit sufficient fluidity. The pressurizing condition may be, for example, 20 MPa or more, and is preferably 25 MPa or more. The pressurizing condition may be, for example, 45 MPa or less, and more preferably 30 MPa or less.

The mixing step may be a step of kneading the melt of the thermoplastic resin, the filler, and the protein short fibers under heating (or under heating and pressurization) to obtain a fluid material. A kneading method is not particularly limited, and examples thereof include a method using a kneader, a mixer, a screw disposed in an extruder or an injection molding machine, and the like.

In the cooling step, the fluid material is cooled. The cooling step may be a step of injecting the fluid material into a die and cooling the fluid material injected into the die. A cooling method is not particularly limited and can be appropriately selected from known methods.

When the fluid material is injected into a die, it is preferable to apply pressure to the fluid material such that the fluid material is injected into the details in the die. In this case, the die is preferably heated in order to prevent the fluid material from being solidified before the inside of the die is sufficiently filled with the fluid material. These pressure and heating conditions can be appropriately adjusted according to the fluidity of the fluid material, the shape of the inside of the die, and the like.

Although the preferred embodiment of the present invention has been described above, the present invention is not limited to the above embodiment.

### EXAMPLES

Hereinafter, the present invention will be described more specifically with reference to Example, but the present invention is not limited to the Example.

<Manufacturing of Spider Silk Fibroin-Like Protein>

(1) Preparation of Plasmid Expression Strain

Based on the base sequence and the amino acid sequence of fibroin (GenBank accession number: P46804.1, GI: 1174415) derived from Nephila clavipes, a modified fibroin having an amino acid sequence represented by SEQ ID NO: 1 (hereinafter, also referred to as “PRT799”) was designed. Note that the amino acid sequence represented by SEQ ID NO: 1 includes an amino acid sequence obtained by performing substitution, insertion, and deletion of an amino acid residue on the amino acid sequence of fibroin derived from Nephila clavipes for the purpose of improving productivity, and further includes an amino acid sequence (tag sequence and hinge sequence) represented by SEQ ID NO: 6 at an N-terminal thereof.

Next, a nucleic acid encoding PRT799 was synthesized. An NdeI site was added to a 5′ end of the nucleic acid, and an EcoRI site was added to a downstream side of a stop codon of the nucleic acid. The nucleic acid was cloned into a cloning vector (pUC118). Then, the nucleic acid was cut out by restriction enzyme treatment with NdeI and EcoRI, and then recombined into a protein expression vector pET-22b(+) to obtain an expression vector.

(2) Expression of Protein

Escherichia coli BLR (DE3) was transformed with a pET22b(+) expression vector containing a nucleic acid encoding a protein having the amino acid sequence represented by SEQ ID NO: 1. The transformed Escherichia coli was cultured in 2 mL of an LB medium containing ampicillin for 15 hours. The culture liquid was added to 100 mL of a seed culture medium (Table 1) containing ampicillin such that OD₆₀₀ was 0.005. The temperature of the culture liquid was maintained at 30° C., and flask culture was performed until OD₆₀₀ reached 5 (about 15 hours) to obtain a seed culture liquid.

TABLE 1
Seed culture medium

| Reagent | Concentration (g/L) |
|---|---|
| Glucose | 5.0 |
| KH₂PO₄ | 4.0 |
| K₂HPO₄ | 9.3 |
| Yeast Extract | 6.0 |
| Ampicillin | 0.1 |

The seed culture liquid was added to a jar fermenter to which 500 mL of a production medium (Table 2) had been added such that OD₆₀₀ was 0.05. Culture was performed by maintaining the temperature of the culture liquid at 37° C. and controlling the pH at a constant value of 6.9. A dissolved oxygen concentration in the culture liquid was maintained at 20% of a dissolved oxygen saturation concentration.

TABLE 2
Production medium

| Reagent | Concentration (g/L) |
|---|---|
| Glucose | 12.0 |
| KH₂PO₄ | 9.0 |
| MgSO₄•7H₂O | 2.4 |
| Yeast Extract | 15 |
| FeSO₄•7H₂O | 0.04 |
| MnSO₄•5H₂O | 0.04 |
| CaCl₂•2H₂O | 0.04 |
| GD-113 (antifoaming agent) | 0.1 (mL/L) |

Immediately after glucose in the production medium was completely consumed, a feed liquid (glucose 455 g/1 L, Yeast Extract 120 g/1 L) was added at a rate of 1 mL/min. Culture was performed by maintaining the temperature of the culture liquid at 37° C. and controlling the pH at a constant value of 6.9. A dissolved oxygen concentration in the culture liquid was maintained at 20% of a dissolved oxygen saturation concentration, and culture was performed for 20 hours. Thereafter, 1 M of isopropyl-β-thiogalactopyranoside (IPTG) was added to the culture liquid such that a final concentration was 1 mM to induce expression of a target protein. Twenty hours after the addition of IPTG, the culture liquid was centrifuged, and bacterial cells were collected. SDS-PAGE was performed using bacterial cells prepared from the culture liquids before and after the addition of IPTG, and expression of the target protein was confirmed by appearance of a band of the size of the target protein depending on the addition of IPTG.

(3) Purification of Protein

Bacterial cells collected two hours after the addition of IPTG were washed with 20 mM Tris-HCl buffer (pH 7.4). The washed bacterial cells were suspended in 20 mM Tris-HCl buffer (pH 7.4) containing about 1 mM PMSF, and the cells were crushed with a high-pressure homogenizer (manufactured by GEA Niro Soavi). The crushed cells were centrifuged to obtain a precipitate. The obtained precipitate was washed with 20 mM Tris-HCl buffer (pH 7.4) until purity became high. The washed precipitate was suspended in 8 M guanidine buffer (8 M guanidine hydrochloride, 10 mM sodium dihydrogen phosphate, 20 mM NaCl, 1 mM Tris-HCl, pH 7.0) so as to have a concentration of 100 mg/mL, stirred with a stirrer at 60° C. for 30 minutes, and dissolved. After dissolution, dialysis was performed with water using a dialysis tube (cellulose tube 36/32 manufactured by Sanko Junyaku Co., Ltd.). A white aggregated protein obtained after dialysis was collected by centrifugation, water was removed by a freeze-dryer, and a freeze-dried powder was collected to obtain a spider silk fibroin-like protein “PRT799”.

<Preparation of Spider Silk Fibroin-Like Protein Fibers>

(1) Preparation of Doping Liquid

The above-described spider silk fibroin-like protein (PRT799) was added to dimethyl sulfoxide (DMSO) so as to have a concentration of 24% by mass, and then LiCl was added thereto as a dissolution accelerator so as to have a concentration of 4.0% by mass. Thereafter, the spider silk fibroin-like protein was dissolved over three hours using a shaker to obtain a DMSO solution. Dust and bubbles in the obtained DMSO solution were removed to prepare a doping liquid. The doping liquid had a solution viscosity of 5000 cP (centipoise) at 90° C.

(2) Spinning

Known dry-wet spinning was performed using the doping liquid obtained as described above and the spinning apparatus 10 illustrated in FIG. 1 to obtain a monofilament formed of a spider silk fibroin-like protein. Note that here, dry-wet spinning was performed under the following conditions.

Extrusion nozzle diameter: 0.1 mm

Extrusion rate: 327.6 mL/hour

Temperature of coagulation liquid (methanol): 2° C.

Winding speed: 99.5 m/min

Stretch ratio: 4.52 times

Drying temperature: 80° C.

Air gap length: 5 mm

<Preparation of Protein Short Fibers>

The spider silk fibroin-like protein fibers (PRT799) were cut to an average length of 5 mm using a desktop fiber cutting machine (NP-300 manufactured by INTEC Inc.) to obtain protein short fibers.

### Example 1

The protein short fibers and Torayca (registered trademark) long fiber pellets (pellets containing carbon fibers and polypropylene, carbon fiber amount: 30% by weight, carbon fiber length: 7 mm, product name “TLP8169”, manufactured by Toray Co., Ltd.) were put into an injection molding machine (EC180SX manufactured by Toshiba Machine Co., Ltd.) at a ratio of 1.25:98.75 (volume ratio), and injection molding was performed to obtain a resin molded article having a size of 150 mm×150 mm×3 mm.

<Fiber Length Distribution of Carbon Fibers>

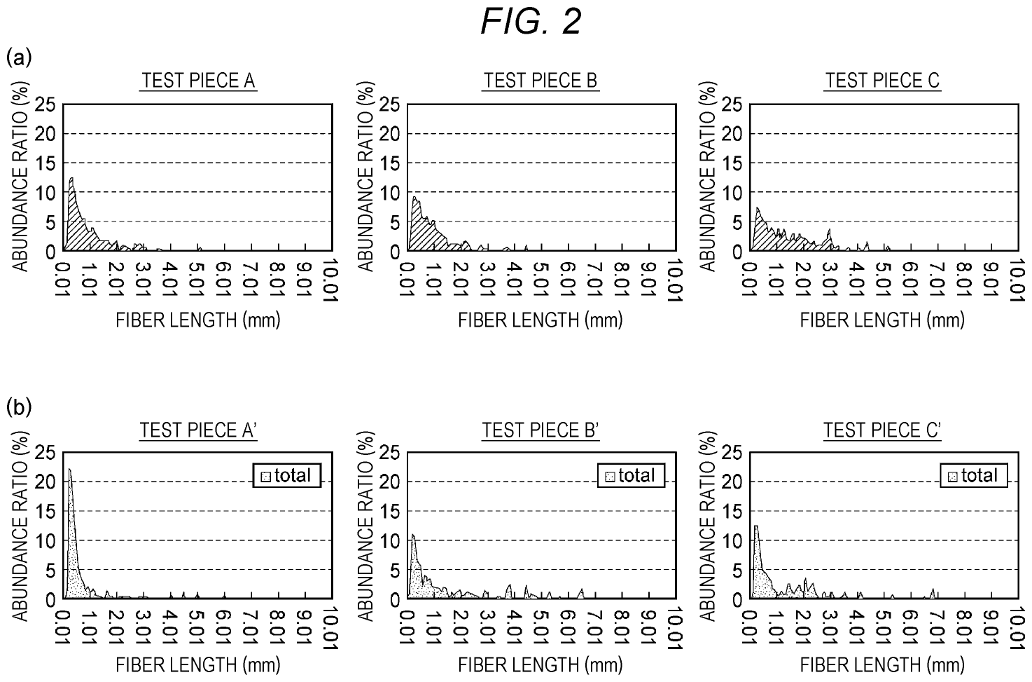

Two test pieces each having a size of 100 mm×15 mm were cut out along one direction (hereinafter, longitudinal direction) of the obtained resin molded article, and used as test pieces A and B. A test piece having a size of 100 mm×15 mm was cut out along a direction orthogonal to the longitudinal direction (hereinafter referred to as a transverse direction), and used as a test piece C. The fiber length distribution of carbon fibers of each of the test pieces was measured using a needle-shaped particle measuring device (LUZEX_AP manufactured by Nireco Corporation). Results are illustrated in FIG. 2(a). Note that in FIG. 2, the abundance ratio on the vertical axis indicates a ratio (%) of the sum of fiber lengths corresponding to each fiber length with respect to the sum of the fiber lengths of the extracted carbon fibers.

<Average Fiber Length of Carbon Fibers>

An average fiber length of carbon fibers in each of the above-described test pieces was calculated. Results are illustrated in Table 3.

<Tensile Characteristics>

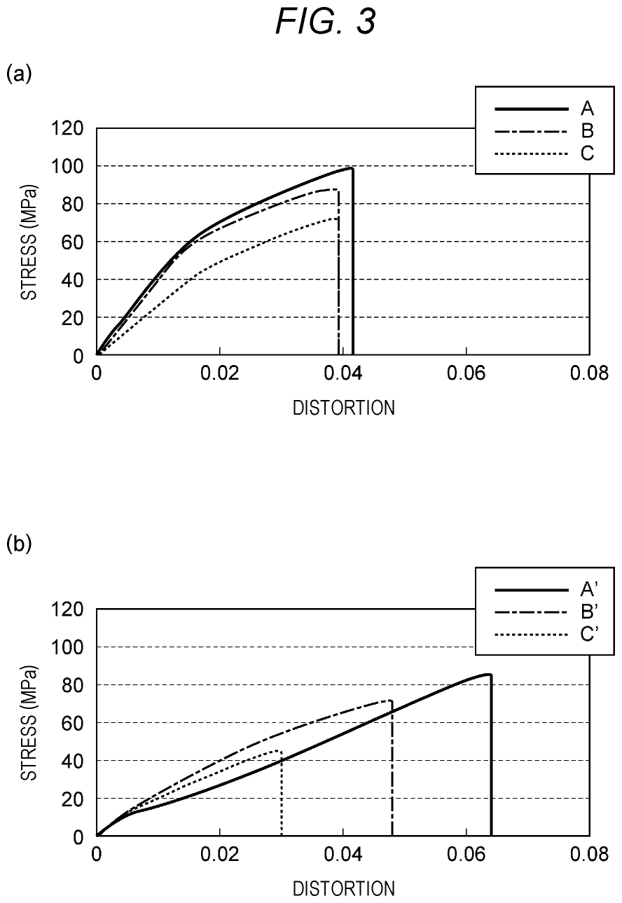

In accordance with JIS K7017, tensile characteristics of each of the above-described test pieces were measured using a tensile tester (AG-50kNX manufactured by Shimadzu Corporation). Results are illustrated in FIG. 3(a).

### Comparative Example 1

A resin molded article was obtained in a similar manner to Example 1 except that the protein short fibers were not used. From the obtained resin molded article, three test pieces were cut out in a similar manner to Example 1, and used as test pieces A′, B′, and C′. The fiber length distribution of carbon fibers, the average fiber length of the carbon fibers, and the tensile characteristics of each of the test pieces were measured. Results are illustrated in FIG. 2(b), Table 3, and FIG. 3(b), respectively.

TABLE 3

| | Example 1 | | | Comparative Example 1 | | |
|---|---|---|---|---|---|---|
| | Test | Test | Test | Test | Test | Test |
| | piece A | piece B | piece C | piece A′ | piece B′ | piece C′ |
| Average fiber | 0.41 | 0.51 | 0.62 | 0.31 | 0.48 | 0.45 |
| length [mm] | | | | | | |

As illustrated in FIG. 3, in Example 1, the abundance ratio of carbon fibers each having a short fiber length was smaller than that in Comparative Example 1. As illustrated in Table 1, in Example 1, the average fiber length of carbon fibers was longer than that in Comparative Example 1.

As illustrated in FIG. 4, in Comparative Example 1, a difference in characteristics depending on a cutting position was large, and tensile characteristics in Example 1 were better than those in Comparative Example 1 over the entire resin molded article.

### INDUSTRIAL APPLICABILITY

The resin molded article of the present invention is a homogeneous resin molded article having good tensile characteristics, and can be preferably used for various applications.

### REFERENCE SIGNS LIST

1 Extrusion device
4 Drying device
6 Doping liquid
10 Spinning apparatus
20 Coagulation bath
21 Washing bath
36 Protein fibers.

1. A resin molded article comprising: a thermoplastic resin; a filler dispersed in the thermoplastic resin; and protein short fibers each having a fiber length of 24 mm or less and dispersed in the thermoplastic resin.

2. The resin molded article according to claim 1, wherein the filler contains carbon fibers.

3. The resin molded article according to claim 1, wherein the protein short fibers contain spider silk fibroin-like protein fibers.

4. The resin molded article according to claim 1, which is a molded article of a kneaded product of the thermoplastic resin, the filler, and the protein short fibers.

5. A method for manufacturing a resin molded article, the method comprising:
a preparatory step of preparing a thermoplastic resin, a filler, and protein short fibers each having a fiber length of 24 mm or less;
a mixing step of obtaining a fluid material containing a melt of the thermoplastic resin, and the filler and the protein short fibers dispersed in the melt; and
a cooling step of cooling the fluid material.

6. The manufacturing method according to claim 5, wherein the mixing step is a step of kneading a melt of the thermoplastic resin, the filler, and the protein short fibers to obtain the fluid material.

7. The manufacturing method according to claim 5, wherein the cooling step is a step of injecting the fluid material into a die and cooling the fluid material injected into the die.

8. The manufacturing method according to claim 5, wherein the filler contains carbon fibers.

9. The manufacturing method according to claim 8, wherein in the preparatory step, a ratio C1/C2 of an average fiber length C1 of the protein short fibers with respect to an average fiber length C2 of the carbon fibers is 0.5/7 to 7/7.

10. The manufacturing method according to claim 5, wherein the protein short fibers contain spider silk fibroin-like protein fibers.


SEQUENCE LISTING (7 sequences)

SEQ ID NO: 1 - protein, 2375 aa, Artificial Sequence
  PRT799
MHHHHHHSSGSSGPGQQGPYGPGASAAAAAGQNGPGSGQQGPGQSGQYGPGQQGPGQQGPGSSAAAAAGPGQYGPGQQGPSASAAAAAGPGSGQQGPGASGQYGPGQQGPGQQGPGSSAAAAAGQYGSGPGQQGPYGSAAAAAGPGSGQYGQGPYGPGASGPGQYGPGQQGPSASAAAAAGSGQQGPGQYGPYASAAAAAGQYGSGPGQQGPYGPGQSGSGQQGPGQQGPYASAAAAAGPGQQGPYGPGSSAAAAAGQYGYGPGQQGPYGPGASGQNGPGSGQYGPGQQGPGQSAAAAAGPGQQGPYGPGASAAAAAGQYGPGQQGPGQYGPGSSGPGQQGPYGPGSSAAAAAGQYGPGQQGPYGPGQSAAAAAGQYQQGPGQQGPYGPGASGPGQQGPYGPGASAAAAAGPGQYGPGQQGPSASAAAAAGQYGSGPGQYGPYGPGQSGPGSGQQGQGPYGPGASAAAAAGQYGPGQQGPYGPGQSAAAAAGPGSGQYGPGASGQNGPGSGQYGPGQQGPGQSAAAAAGQYQQGPGQQGPYGPGASAAAAAGQYGSGPGQQGPYGPGQSGSGQQGPGQQGPYASAAAAAGPGSGQQGPGASGQQGPYGPGASAAAAAGQNGPGSGQQGPGQSGQYGPGQQGPGQQGPGSSAAAAAGPGQYGPGQQGPSASAAAAAGPGSGQQGPGASGQYGPGQQGPGQQGPGSSAAAAAGQYGSGPGQQGPYGSAAAAAGPGSGQYGQGPYGPGASGPGQYGPGQQGPSASAAAAAGSGQQGPGQYGPYASAAAAAGQYGSGPGQQGPYGPGQSGSGQQGPGQQGPYASAAAAAGPGQQGPYGPGSSAAAAAGQYGYGPGQQGPYGPGASGQNGPGSGQYGPGQQGPGQSAAAAAGPGQQGPYGPGASAAAAAGQYGPGQQGPGQYGPGSSGPGQQGPYGPGSSAAAAAGQYGPGQQGPYGPGQSAAAAAGQYQQGPGQQGPYGPGASGPGQQGPYGPGASAAAAAGPGQYGPGQQGPSASAAAAAGQYGSGPGQYGPYGPGQSGPGSGQQGQGPYGPGASAAAAAGQYGPGQQGPYGPGQSAAAAAGPGSGQYGPGASGQNGPGSGQYGPGQQGPGQSAAAAAGQYQQGPGQQGPYGPGASAAAAAGQYGSGPGQQGPYGPGQSGSGQQGPGQQGPYASAAAAAGPGSGQQGPGASGQQGPYGPGASAAAAAGQNGPGSGQQGPGQSGQYGPGQQGPGQQGPGSSAAAAAGPGQYGPGQQGPSASAAAAAGPGSGQQGPGASGQYGPGQQGPGQQGPGSSAAAAAGQYGSGPGQQGPYGSAAAAAGPGSGQYGQGPYGPGASGPGQYGPGQQGPSASAAAAAGSGQQGPGQYGPYASAAAAAGQYGSGPGQQGPYGPGQSGSGQQGPGQQGPYASAAAAAGPGQQGPYGPGSSAAAAAGQYGYGPGQQGPYGPGASGQNGPGSGQYGPGQQGPGQSAAAAAGPGQQGPYGPGASAAAAAGQYGPGQQGPGQYGPGSSGPGQQGPYGPGSSAAAAAGQYGPGQQGPYGPGQSAAAAAGQYQQGPGQQGPYGPGASGPGQQGPYGPGASAAAAAGPGQYGPGQQGPSASAAAAAGQYGSGPGQYGPYGPGQSGPGSGQQGQGPYGPGASAAAAAGQYGPGQQGPYGPGQSAAAAAGPGSGQYGPGASGQNGPGSGQYGPGQQGPGQSAAAAAGQYQQGPGQQGPYGPGASAAAAAGQYGSGPGQQGPYGPGQSGSGQQGPGQQGPYASAAAAAGPGSGQQGPGASGQQGPYGPGASAAAAAGQNGPGSGQQGPGQSGQYGPGQQGPGQQGPGSSAAAAAGPGQYGPGQQGPSASAAAAAGPGSGQQGPGASGQYGPGQQGPGQQGPGSSAAAAAGQYGSGPGQQGPYGSAAAAAGPGSGQYGQGPYGPGASGPGQYGPGQQGPSASAAAAAGSGQQGPGQYGPYASAAAAAGQYGSGPGQQGPYGPGQSGSGQQGPGQQGPYASAAAAAGPGQQGPYGPGSSAAAAAGQYGYGPGQQGPYGPGASGQNGPGSGQYGPGQQGPGQSAAAAAGPGQQGPYGPGASAAAAAGQYGPGQQGPGQYGPGSSGPGQQGPYGPGSSAAAAAGQYGPGQQGPYGPGQSAAAAAGQYQQGPGQQGPYGPGASGPGQQGPYGPGASAAAAAGPGQYGPGQQGPSASAAAAAGQYGSGPGQYGPYGPGQSGPGSGQQGQGPYGPGASAAAAAGQYGPGQQGPYGPGQSAAAAAGPGSGQYGPGASGQNGPGSGQYGPGQQGPGQSAAAAAGQYQQGPGQQGPYGPGASAAAAAGQYGSGPGQQGPYGPGQSGSGQQGPGQQGPYASAAAAAGPGSGQQGSSVDKLAAALEHHHHHH

SEQ ID NO: 2 - protein, 252 aa, Artificial Sequence
  Collagen-type4-Kai
MHHHHHHSSGSSKDGVPGFPGSEGVKGNRGFPGLMGEDGIKGQKGDIGPPGFRGPTEYYDTYQEKGDEGTPGPPGPRGARGPQGPSGPPGVPGSPGSSRPGLRGAPGWPGLKGSKGERGRPGKDAMGTPGSPGCAGSPGLPGSPGPPGPPGDIVFRKGPPGDHGLPGYLGSPGIPGVDGPKGEPGLLCTQCPYIPGPPGLPGLPGLHGVKGIPGRQGAAGLKGSPGSPGNTGLPGFPGFPGAQGDPGLKGEK

SEQ ID NO: 3 - protein, 310 aa, Artificial Sequence
  Resilin-Kai
MHHHHHHPEPPVNSYLPPSDSYGAPGQSGPGGRPSDSYGAPGGGNGGRPSDSYGAPGQGQGQGQGQGGYAGKPSDSYGAPGGGDGNGGRPSSSYGAPGGGNGGRPSDTYGAPGGGNGGRPSDTYGAPGGGGNGNGGRPSSSYGAPGQGQGNGNGGRPSSSYGAPGGGNGGRPSDTYGAPGGGNGGRPSDTYGAPGGGNNGGRPSSSYGAPGGGNGGRPSDTYGAPGGGNGNGSGGRPSSSYGAPGQGQGGFGGRPSDSYGAPGQNQKPSDSYGAPGSGNGNGGRPSSSYGAPGSGPGGRPSDSYGPPASG

SEQ ID NO: 4 - protein, 282 aa, Artificial Sequence
  elastin short
MHHHHHHSSGSSLGVSAGAVVPQPGAGVKPGKVPGVGLPGVYPGGVLPGARFPGVGVLPGVPTGAGVKPKAPGVGGAFAGIPGVGPFGGPQPGVPLGYPIKAPKLPGGYGLPYTTGKLPYGYGPGGVAGAAGKAGYPTGTGVGPQAAAAAAAKAAAKFGAGAAGVLPGVGGAGVPGVPGAIPGIGGIAGVGTPAAAAAAAAAAKAAKYGAAAGLVPGGPGFGPGVVGVPGAGVPGVGVPGAGIPVVPGAGIPGAAVPGVVSPEAAAKAAAKAAKYGARPGVG

SEQ ID NO: 5 - protein, 468 aa, Artificial Sequence
  type I keratin 26
MSFRLSGVSRRLCSQAGTGRLTGGRTGFRAGNVCSGLGAGSSFSGPLGSVSSKGSFSHGGGGLGSGVCTGFLENEHGLLPGNEKVTLQNLNDRLASYLDHVCTLEEANADLEQKIKGWYEKYGPGSGRQLAHDYSKYFSVTEDLKRQIISVTTCNASIVLQNENARLTADDFRLKCENELALHQSVEADINGLHRVMDELTLCTSDLEMQCEALSEELTYLKKNHQEEMKVMQGAARGNVNVEINAAPGVDLTVLLNNMRAEYEDLAEQNHEDAEAWFSEKSTSLHQQISDDAGAAMAARNELMELKRNLQTLEIELQSLLAMKHSYECSLAETESNYCHQLQQIQEQIGAMEDQLQQIRMETEGQKLEHERLLDVKIFLEKEIEMYCKLIDGEGRKSKSTCYKSEGRGPKNSENQVKDSKEEAVVKTVVGELDQLGSVLSLRVHSVEEKSSKISNITMEQRLPSKVP

SEQ ID NO: 6 - protein, 12 aa, Artificial Sequence
  His6Tag plus Hinge
MHHHHHHSSGSS

SEQ ID NO: 7 - protein, 7 aa, Artificial Sequence
  His6Tag
MHHHHHH